(19) United States
(12) Patent Application Publication
(10) Pub. No.: US 2009/0021734 A1
(43) Pub. Date: Jan. 22, 2009

(54) APPARATUS AND METHOD FOR DETECTING SUSPENDED PARTICLES

(75) Inventors: Taketo SHIBA, Kanagawa-ken (JP); Masaaki Furuya, Kanagawa-ken (JP); Masahiko Takahashi, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/142,303

(22) Filed: Jun. 19, 2008

(30) Foreign Application Priority Data
Jun. 20, 2007 (JP) 2007-162463

(51) Int. Cl. G01N 21/47

(52) U.S. Cl. 356/336

(57) ABSTRACT

An apparatus for detecting suspended particles, includes a laser source configured to emit a beam of laser light, a diameter expander configured to expand the diameter of the beam, and a distributor configured to distribute the laser light in a sheet-like space, the distributor varying the traveling direction of the laser light in continuous directions at a fixed angle with respect to a reference axis.

### CROSS-REFERENCE TO RELATED APPLICATIONS

This application is based upon and claims the benefit of priority from the prior Japanese Patent Application No. 2007-162463, filed on Jun. 20, 2007; the entire contents of which are incorporated herein by reference.

### BACKGROUND OF THE INVENTION

1. Field of the Invention

This invention relates to an apparatus and method for detecting suspended particles, and more particularly to an apparatus and method for detecting suspended particles using laser light.

2. Background Art

Semiconductor devices and liquid crystal devices are manufactured in a clean room to prevent particle contamination. A level of cleanliness meeting a prescribed standard must be constantly maintained in the clean room. To this end, the density and size of particles suspended in the air need to be regularly evaluated. Furthermore, upon abnormal increase of particles in the clean room, it is necessary to track the source and take measures against it. For this reason, there is a need for an apparatus for detecting particles suspended in the air.

For example, in the technique disclosed in JP-A 61-288138 (Kokai) (1986), while laser light is emitted in a box, air present at a place to be tested is sucked into the box and allowed to traverse the optical path of the laser light. Thus, if any particle is contained in the sucked air, the laser light is reflected by the particle. Hence, by detecting this reflected light, the number of particles can be counted. However, in this technique, although the number of particles can be measured, the detailed position, incoming direction, and timing of the particle cannot be detected because air present at the place under test is sucked into the box. Thus, unfortunately, it is impossible to analyze the flow of particles and identify the source of particles.

In the technique disclosed in JP-A 61-262633 (Kokai) (1986), a beam of laser light is emitted in a clean room while varying the beam direction, and a scattered light, which occurs when a particle is irradiated with the laser light, is detected. However, also in this technique, the particle flashes instantaneously only when it traverses the optical path of the laser light. Hence, unfortunately, although the position and incoming timing of the particle can be detected to some extent, the incoming direction of the particle cannot be detected.

### SUMMARY OF THE INVENTION

According to an aspect of the invention, there is provided an apparatus for detecting suspended particles, including: a laser source configured to emit a beam of laser light; a diameter expander configured to expand the diameter of the beam; and a distributor configured to distribute the laser light in a sheet-like space.

According to another aspect of the invention, there is provided a method for detecting suspended particles, including: expanding the diameter of a beam of laser light; distributing the laser light in a sheet-like space; and detecting the laser light reflected by a particle traveling in the sheet-like space.

### BRIEF DESCRIPTION OF THE DRAWINGS

FIG. 1 illustrates a suspended particle detector according to a first embodiment of the invention;

FIGS. 2A to 2C illustrate beam shapes in the first embodiment;

FIG. 3 is a perspective view illustrating the diameter expander shown in FIG. 1;

FIG. 4 is a side view illustrating the rotary mirror shown in FIG. 1;

FIG. 5 illustrates a method for imaging suspended particles in the first embodiment;

FIGS. 6A and 6B illustrate image data obtained by the imaging shown in FIG. 5;

FIG. 7 is a side view illustrating an optical unit in a suspended particle detector according to a second embodiment of the invention;

FIG. 8 is a perspective view illustrating a cylindrical lens in a third embodiment of the invention;

FIGS. 9A and 9B are optical model diagrams illustrating the operation of the cylindrical lens shown in FIG. 8;

FIG. 10 is a plan view illustrating a suspended particle detector according to a fourth embodiment of the invention;

FIG. 11 is an optical model diagram illustrating the operation of the diameter expander, the distributor, and the collimator of the suspended particle detector shown in FIG. 10; and

FIG. 12 is a side view illustrating a jig used in a fifth embodiment of the invention.

### DETAILED DESCRIPTION OF THE INVENTION

Embodiments of the invention will now be described with reference to the drawings, starting with a first embodiment of the invention.

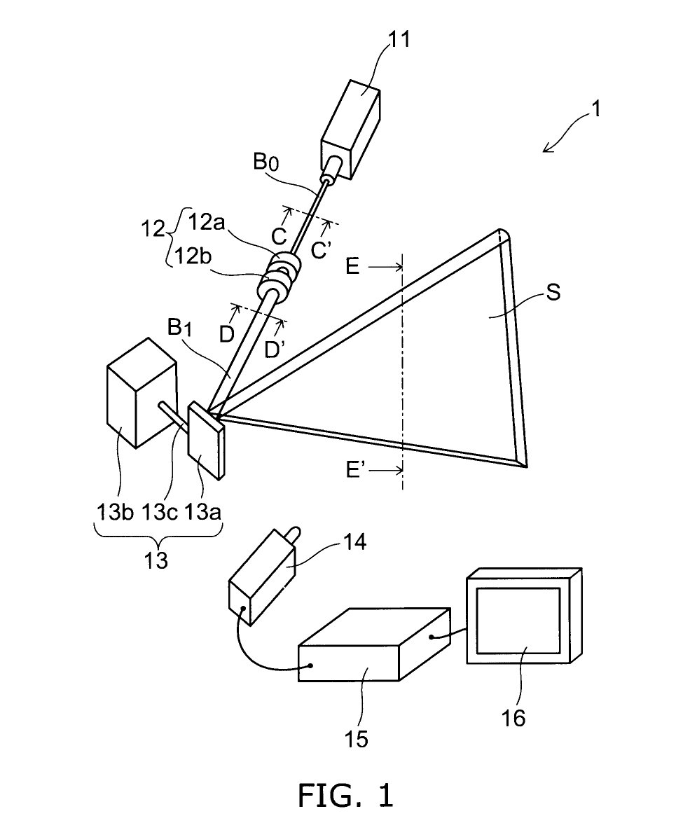

FIG. 1 illustrates a suspended particle detector according to this embodiment.

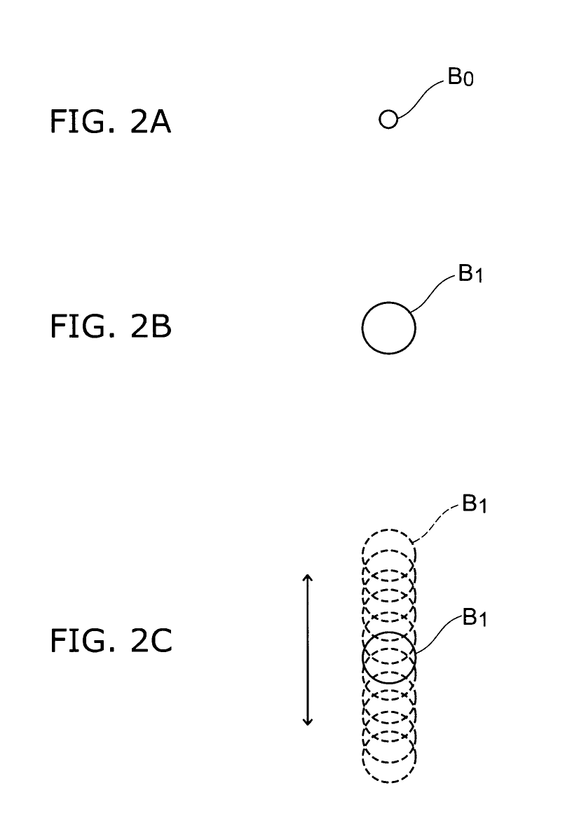

FIGS. 2A to 2C illustrate beam shapes in this embodiment, where FIG. 2A shows a shape at line C-C′ shown in FIG. 1, FIG. 2B shows a shape at line D-D′, and FIG. 2C shows a shape at line E-E′.

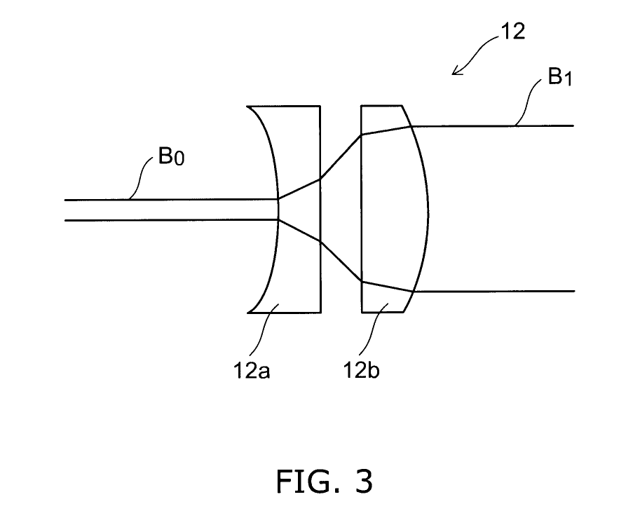

FIG. 3 is a perspective view illustrating the diameter expander shown in FIG. 1.

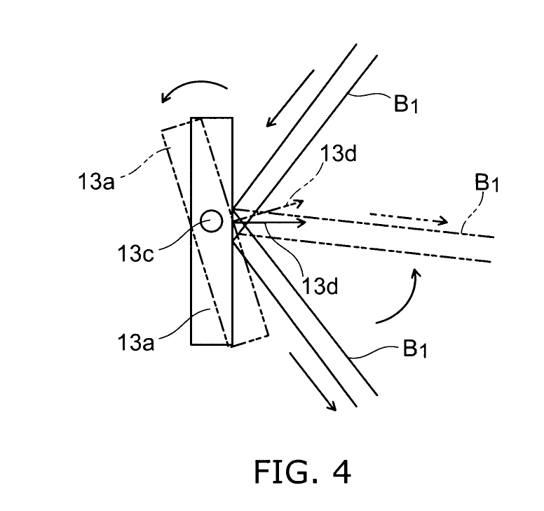

FIG. 4 is a side view illustrating the rotary mirror shown in FIG. 1.

As shown in FIG. 1, the suspended particle detector 1 according to this embodiment comprises a laser source 11. The laser source 11 is operable to emit a laser light beam B₀. As shown in FIG. 2A, the beam B₀ has a circular shape. A diameter expander 12 for expanding the diameter of the beam B₀ is disposed at a position irradiated with the beam B₀ emitted from the laser source 11.

As shown in FIG. 3, the diameter expander 12 illustratively includes a plano-concave lens 12a and a plano-convex lens 12b. The central axis of the plano-concave lens 12a and the central axis of the plano-convex lens 12b coincide with the optical axis of the beam B₀. On the optical path of the beam B₀, the plano-concave lens 12a is placed on the laser source 11 side of the plano-convex lens 12b. The traveling direction of the laser light constituting the beam B₀ expands by passing through the plano-concave lens 12a and is collimated by passing through the plano-convex lens 12b. Thus, as shown in FIG. 2B, the beam B₀ is expanded in diameter while remaining a circular parallel light, resulting in a beam B₁.

The suspended particle detector 1 further comprises a rotary mirror 13 serving as a distributor at a position irradiated with the beam B₁ that has passed through the diameter expander 12.

As shown in FIG. 4, the rotary mirror 13 illustratively includes a mirror 13a for reflecting the beam B₁ and a driver 13b for rotating the mirror 13a. The driver 13b is operable to rotate the mirror 13a within a prescribed angle range about an axis 13c parallel to the mirror surface. Thus the normal direction 13d of the mirror 13a rotates about the axis 13c. Consequently, as shown in FIG. 2C, the traveling direction of the beam B₁ continuously varies at a fixed angle with respect to the axis 13c.

Thus the optical path of the beam B₁ periodically varies, and the trajectory of the optical path of the beam B₁ forms a sheet-like space S. In other words, the rotary mirror 13 distributes the laser light constituting the beam B₁ in a sheet-like space S. The sheet-like space S refers to a quasi-two-dimensional space sandwiched between two planes placed parallel to each other, and the thickness, that is, the spacing between these two planes, is equal to the diameter of the diameter-expanded beam B₁. Furthermore, the isointensity curves of the time-integrated intensity of laser light in the space S, in which the intensity is integrated with respect to time in integer multiples of the rotation period, form concentric circles about the axis 13c.

The suspended particle detector 1 further comprises a camera 14. The camera 14 is placed outside the space S and oriented so that the space S can be imaged. The camera 14 is operable to image the space S and obtain an image data. When the above laser light is reflected by a particle traveling in the space S, the camera 14 can detect the reflected light. The camera 14 is illustratively a night-vision camera.

An image processor 15 is connected to the camera 14. The image processor 15 applies image processing to the image data obtained by the camera 14 to emphasize a portion corresponding to the particle in the image data. This image processing is illustratively differentiation processing, and the image processor 15 illustratively includes a differentiation circuit. The image processor 15 further includes a store for storing image data.

The suspended particle detector 1 further comprises a display 16, which is connected to the image processor 15. The display 16 is operable to display the image taken by the camera 14 and the image processed by the image processor 15, and is illustratively a liquid crystal monitor.

Next, the operation of the suspended particle detector according to this embodiment as configured above, that is, a method for detecting suspended particles according to this embodiment, is described.

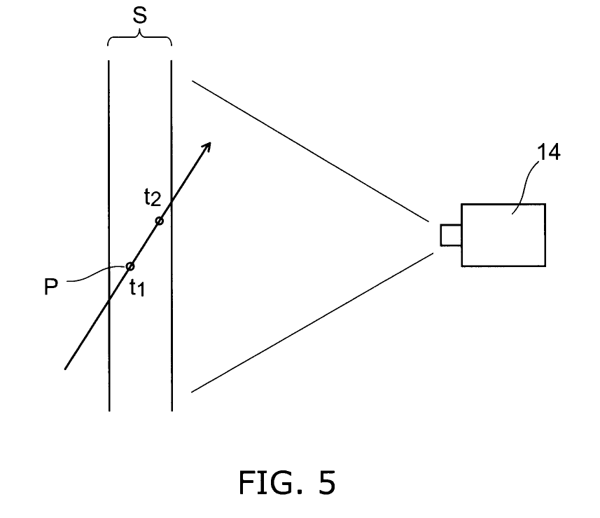

FIG. 5 illustrates a method for imaging suspended particles in this embodiment.

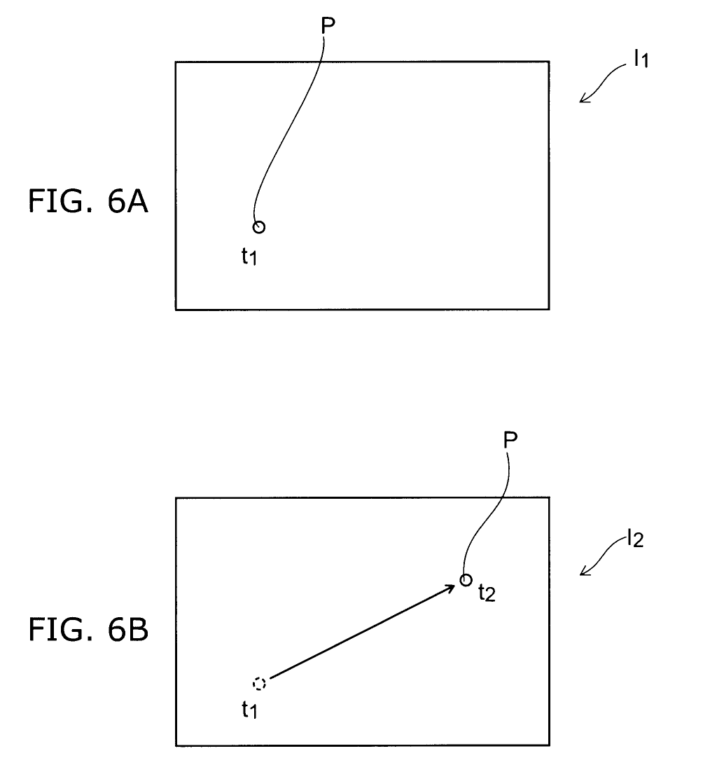

FIGS. 6A and 6B illustrate image data obtained by the imaging shown in FIG. 5, where FIG. 6A shows the image data at time t₁, and FIG. 6B shows the image data at time t₂, which is subsequent to time t₁.

First, as shown in FIGS. 1 and 4, the driver 13b of the rotary mirror 13 is activated. Thus the mirror 13a rotates about the axis 13c, and the normal direction 13d of the mirror 13a rotates about the axis 13c. The period of this rotation is illustratively set to 1/60 seconds.

In this condition, as shown in FIG. 1, the laser source 11 is caused to emit a laser light beam B₀. The beam B₀ has a circular shape, and has a diameter of several millimeters, e.g., approximately 1 to 2 millimeters. The beam B₀ emitted from the laser source 11 impinges on the diameter expander 12. Thus, as shown in FIG. 3, the traveling direction of the laser light constituting the beam B₀ expands by passing through the plano-concave lens 12a and is collimated by passing through the plano-convex lens 12b. Consequently, the beam B₀ is expanded in diameter, resulting in a beam B₁. The diameter-expanded beam B₁ has a circular shape, and has a diameter of e.g. approximately 50 millimeters.

As shown in FIG. 4, the beam B₁ emitted from the diameter expander 12 reaches the mirror 13a of the rotary mirror 13 and is reflected. At this time, the normal direction 13d of the mirror 13a is rotating about the axis 13c. Hence the traveling direction of the reflected beam B₁ also rotates about the axis 13c and continuously varies at a fixed angle with respect to the axis 13c. Thus the trajectory of the optical path of the beam B₁ forms a sheet-like space S. Consequently, the laser light is distributed in the space S.

On the other hand, the camera 14, the image processor 15, and the display 16 are activated. The imaging speed of the camera 14 is illustratively 1/30 seconds. In this case, the beam B₁ undergoes two round trips in the sheet-like space S while the camera 14 takes one frame.

In this condition, as shown in FIG. 5, when a particle P suspended in the air travels in the sheet-like space S, the particle P is irradiated with laser light, which is reflected by the particle P. Part of the reflected light reaches the camera 14 and is detected. Thus the particle P is recorded in the image data obtained by the camera 14.

Then, as shown in FIG. 1, the image processor 15 applies image processing such as differentiation processing to this image data to emphasize a portion corresponding to the particle. The image processor 15 can store unprocessed and processed image data. The image processor 15 successively causes the display 16 to display the processed image. Alternatively, a human inspector can cause the display 16 to display any image stored in the image processor 15. Thus the number of particles that have passed through the space S and the passage timing thereof can be determined.

Here, this embodiment includes the diameter expander 12. Thus, the beam B₀ emitted from the laser source 11 is expanded in diameter by the diameter expander 12, resulting in a beam B₁, which is then distributed by the rotary mirror 13. Hence the sheet-like space S has a large thickness. Thus, when a particle P travels in the sheet-like space S, it has a long residence time in the space S, increasing the possibility that the camera 14 captures the particle P in a plurality of frames. Furthermore, the particle P has a long trajectory in the space S. Thus, when the particle P is captured in a plurality of frames, the distance between the position of the particle P in the first of the frames and the position of the particle P in the last of the frames is increased.

More specifically, as shown in FIG. 5, when a particle P travels in the space S, the camera 14 can image the particle P at both times t₁ and t₂. By comparison between the position of the particle P in the image I₁ at time t₁ shown in FIG. 6A and the position of the particle P in the image I₂ at time t₂ shown in FIG. 6B, the incoming direction and incoming velocity of the particle P can be estimated.

However, if the diameter expander 12 is not provided, the thickness of the sheet-like space S is equal to the diameter of the unexpanded beam B₀, e.g., 1 to 2 millimeters. Thus, when a particle P travels in the space S, it has a shorter residence time in the space S, and it is difficult for the camera 14 to capture the particle P in a plurality of frames. Hence the incoming direction and incoming velocity of the particle P cannot be estimated. Furthermore, even if the camera 14 has captured the particle P in a plurality of frames, the particle P has a shorter trajectory in the space S. Hence the positions of the particle P in the frame images are closer to each other. Thus the incoming direction and incoming velocity of the particle P cannot be estimated precisely.

Next, the effect of this embodiment is described.

As described above, this embodiment includes the diameter expander 12 for expanding the beam diameter. This increases the thickness of the sheet-like space S in which laser light is distributed, as compared with the case without the diameter expander 12. Hence the incoming direction and incoming velocity of a particle can be detected. Thus, in addition to the number of particles and the occurrence timing thereof, the incoming direction and incoming velocity thereof can be detected, which facilitates identifying the source and traveling path of particles.

In this embodiment, the light receiving section of the camera 14 can be covered with a band-pass filter, the transmittance of which to light in the wavelength band including the wavelength of the laser light is higher than its transmittance to light having wavelengths outside this wavelength band. In this case, the light reflected by a particle impinges on the camera 14 after passing through this band-pass filter. Thus, the camera 14 can efficiently receive the reflected light of the laser light while most of the ambient light can be blocked. Consequently, also in a bright surrounding environment, the SNR (signal-to-noise ratio) of the detection result can be improved to achieve precise detection. This facilitates particle detection in an operating factory, for example.

In this embodiment, the image processor 15 can include circuits or programs other than the differentiation circuit. For example, a streamline display software can be installed to display the trajectory of detected particles using streamlines. Furthermore, the image processor 15 can include a circuit or program for identifying blips corresponding to the same particle among the images when a plurality of particles are simultaneously detected. This allows automatic tracking of individual particles.

In this embodiment, the distributor can be a polygon mirror instead of the rotary mirror 13. In this case, the polygon mirror comprises a polygonal prism with side faces made of mirrors, and a driver for rotating the polygonal prism about its central axis. Thus the driver can vary the normal direction of each mirror of the polygonal prism about the central axis of the polygonal prism, achieving an optical action similar to that of the rotary mirror.

Furthermore, this embodiment can include a plurality of cameras 14 for imaging the sheet-like space S from different directions. Thus the position of a particle P can be ascertained three-dimensionally, and the incoming direction and incoming velocity of the particle P can be estimated more precisely.

Moreover, instead of providing the camera 14, the image processor 15, and the display 16 in the suspended particle detector 1 according to this embodiment, a human inspector can observe the light reflected by a particle P with the naked eye. In this case, if the rotation speed of the mirror 13a is sufficiently increased, the inspector can see a linear trajectory of the particle P by persistence of vision. Furthermore, the trajectory of the particle P can be ascertained three-dimensionally to some extent because of the human capability of spectroscopy. Thus the incoming direction of the particle P can be intuitively detected. Moreover, if the particle P has a relatively low incoming velocity, the incoming velocity can also be estimated to some extent. It is noted that observation can be performed through a band-pass filter also in the case of observation by a human inspector with the naked eye.

Next, a second embodiment of the invention is described.

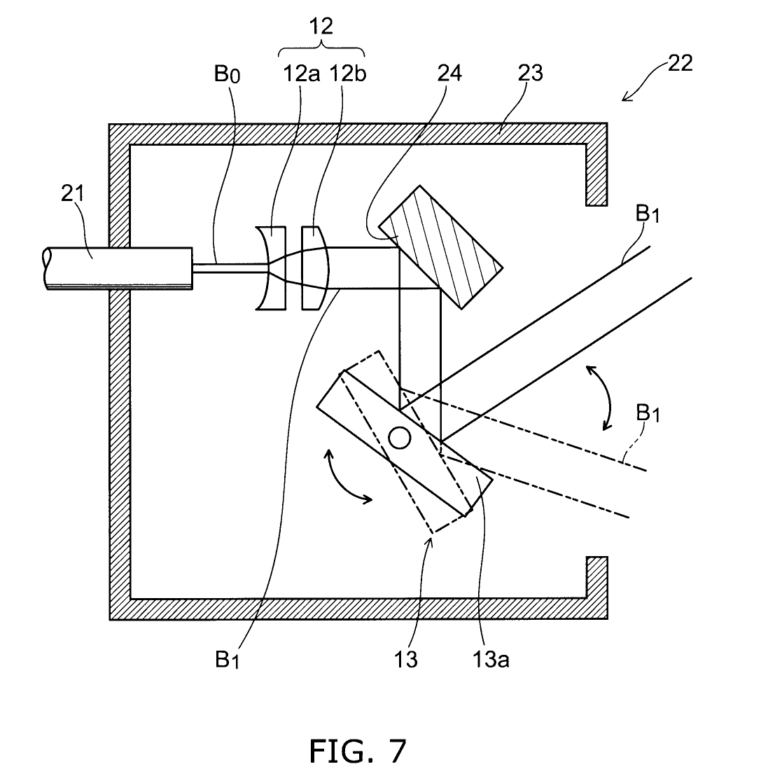

FIG. 7 is a side view illustrating an optical unit in a suspended particle detector according to this embodiment.

As shown in FIG. 7, the suspended particle detector according to this embodiment comprises an optical fiber 21 with one end coupled to a laser source 11 (see FIG. 1). The suspended particle detector further comprises an optical unit 22 coupled to the other end of the optical fiber 21 and integrally composed of a diameter expander 12 and a rotary mirror 13.

The optical unit 22 includes a housing 23, to which the other end of the optical fiber 21 is coupled. In the housing 23, the plano-concave lens 12a and the plano-convex lens 12b of the diameter expander 12 are installed at a position where a laser light beam B₀ emitted from the other end of the optical fiber 21 is incoming. Furthermore, in the housing 23, a mirror 24 is installed at a position where the beam B₁ expanded in diameter by the diameter expander 12 is incoming. The reflecting surface of the mirror 24 is inclined at approximately 45 degrees with respect to the optical axis of the beam B₁. Furthermore, a rotary mirror 13 is also installed in the housing 23. The mirror 13a of the rotary mirror 13 is placed at a position where the light reflected by the mirror 24 is incoming. The laser light reflected by the mirror 13a of the rotary mirror 13 is emitted to the outside of the optical unit 22. The configuration other than the foregoing in this embodiment is the same as that in the above first embodiment.

Next, the operation of this embodiment is described.

In the suspended particle detector according to this embodiment, the laser light emitted from the laser source 11 (see FIG. 1) is propagated in the optical fiber 21, guided into the housing 23 of the optical unit 22, diameter-expanded by the diameter expander 12, reflected by the mirror 24, then distributed by the rotary mirror 13, and emitted from the optical unit 22 to form a sheet-like space S. The operation other than the foregoing in this embodiment is the same as that in the above first embodiment.

Next, the effect of this embodiment is described.

According to this embodiment, the optical unit 22 is integrally composed of the diameter expander 12 and the rotary mirror 13, and the optical unit 22 is optically coupled to the laser source 11 through the optical fiber 21. Thus the optical positional relationship among the laser source 11, the diameter expander 12, and the rotary mirror 13 is fixed. Hence there is no need to readjust the positional relationship thereof at each time of detection.

Furthermore, because the laser source 11 is optically coupled to the optical unit 22 through the optical fiber 21, the positional relationship therebetween allows certain flexibility. Hence, for example, with the laser source 11 left on the floor, the position of the optical unit 21 can be selected arbitrarily within a certain range. Moreover, there is no leakage of laser light outside the optical path from the laser source 11 to the rotary mirror 13. Hence the surrounding environment is not affected by any leaked laser light, and a high utilization efficiency of laser light is achieved. Furthermore, there is no contamination by dust and other foreign matter on this optical path, achieving a high utilization efficiency of laser light. The effect other than the foregoing in this embodiment is the same as that in the above first embodiment.

Next, a third embodiment of the invention is described.

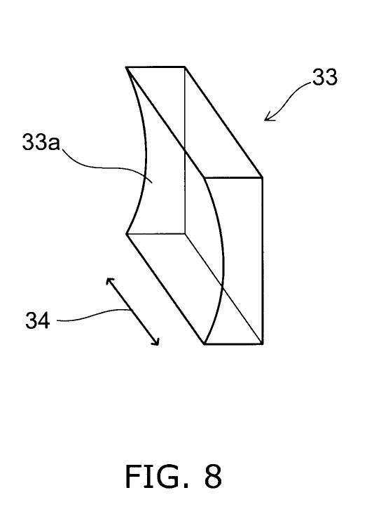

FIG. 8 is a perspective view illustrating a cylindrical lens in this embodiment.

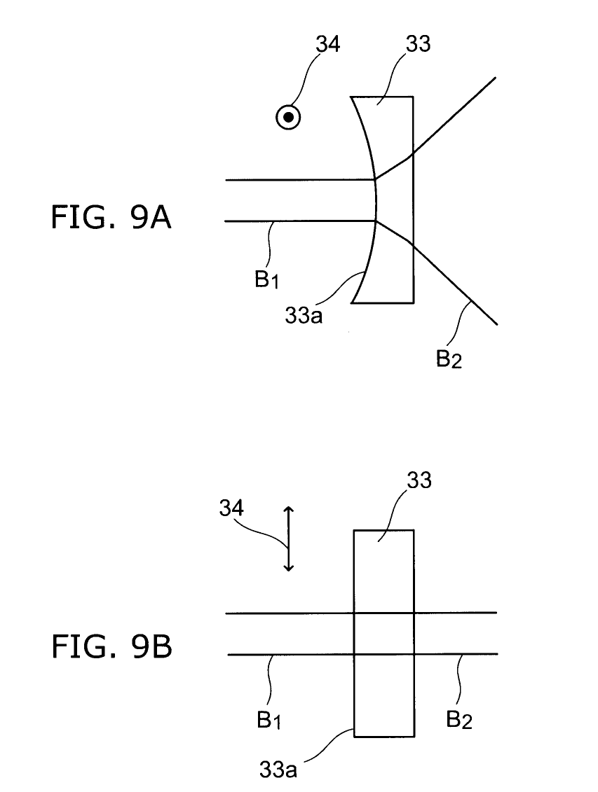

FIGS. 9A and 9B are optical model diagrams illustrating the operation of the cylindrical lens shown in FIG. 8, where FIG. 9A shows the cylindrical lens as viewed from its extending direction, and FIG. 9B shows the cylindrical lens as viewed from the direction orthogonal to both the beam optical axis and the extending direction of the cylindrical lens.

As shown in FIG. 8, in the suspended particle detector according to this embodiment, instead of the rotary mirror 13 shown in the above first embodiment (see FIGS. 1 and 4), a cylindrical lens 33 is provided as a distributor for distributing laser light in a sheet-like space S. The cylindrical lens 33 is a cylindrical plano-concave lens, extending along the axial direction 34, and the lens surface 33a is curved one-dimensionally along a direction orthogonal to the axial direction 34. The configuration other than the foregoing in this embodiment is the same as that in the above first embodiment.

As shown in FIGS. 9A and 9B, among the directions orthogonal to the traveling direction of a beam B₁ incident on the cylindrical lens 33, the beam B₁ is expanded only in the direction orthogonal to the axial direction 34, that is, the curving direction of the lens surface 33a, and not expanded in the axial direction 34. Thus, by passing through the cylindrical lens 33, the traveling direction of the laser light constituting the beam B₁ varies in spatially continuous directions at a fixed angle, e.g., orthogonal, with respect to the axial direction 34. Consequently, the circular beam B₁ is turned into a beam B₂ having a shape elongated in one direction, which is distributed in a sheet-like space S (see FIG. 1). The operation other than the foregoing in this embodiment is the same as that in the above first embodiment.

According to this embodiment, the distributor is made of a cylindrical lens, and hence can be implemented in a simple configuration without using a driving section. Consequently, a small, cost-effective, and reliable suspended particle detector can be realized. The configuration other than the foregoing in this embodiment is the same as that in the above first embodiment.

Next, a fourth embodiment of the invention is described.

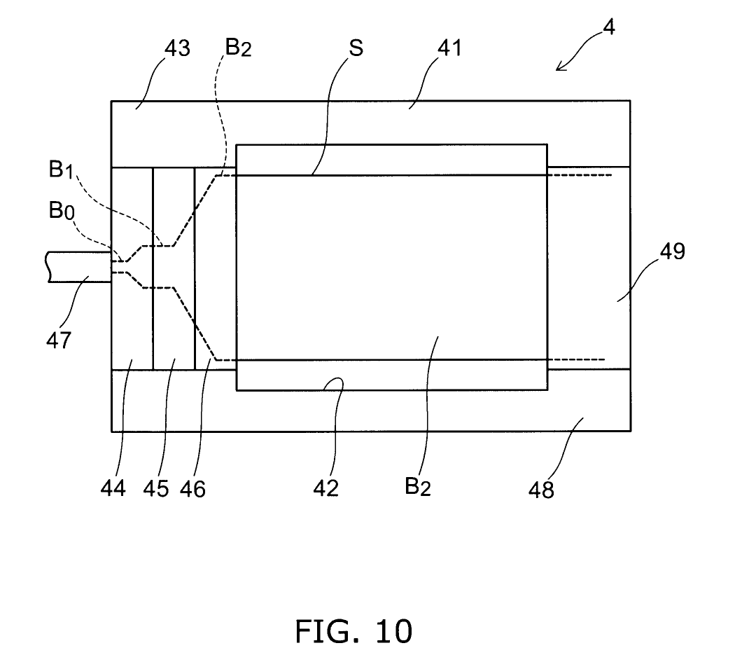

FIG. 10 is a plan view illustrating a suspended particle detector according to this embodiment.

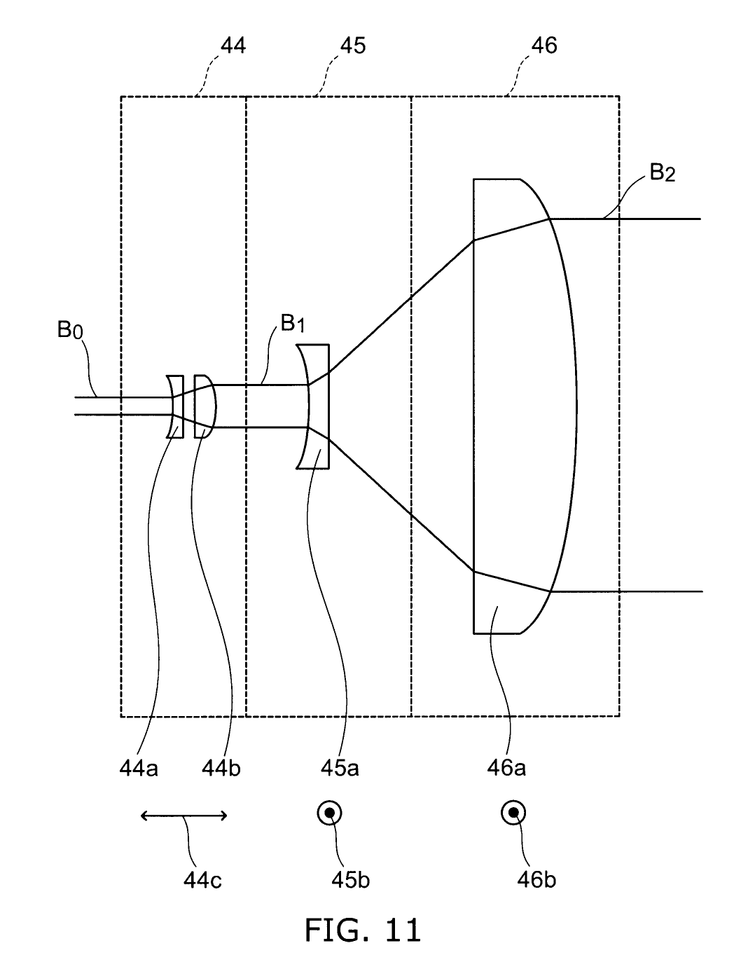

FIG. 11 is an optical model diagram illustrating the operation of the diameter expander, the distributor, and the collimator of the suspended particle detector shown in FIG. 10.

As shown in FIG. 10, the suspended particle detector 4 according to this embodiment comprises a framework 41 for integrally holding a diameter expander, a distributor, and the like. The framework 41 is illustratively a rectangular frame made of four sides, and the region surrounded by the sides constitutes an opening 42. A diameter expander 44, a distributor 45, and a collimator 46 are installed on one side 43 of the framework 41 sequentially from the outside of the framework 41. A laser source 11 (see FIG. 1) is provided outside the framework 41, and an optical fiber 47 for optically coupling the laser source 11 to the diameter expander 44 is provided.

As shown in FIG. 11, the diameter expander 44 includes a plano-concave lens 44a and a plano-convex lens 44b, each being not a cylindrical lens, but a normal circular lens. The optical axes of these lenses coincide with each other. The extending direction 44c of this optical axis coincides with the arrayed direction of the diameter expander 44, the distributor 45, and the collimator 46. The distributor 45 includes a cylindrical lens 45a of the cylindrical plano-concave type. The collimator 46 includes a cylindrical lens 46a of the cylindrical plano-convex type. The extending direction (axial direction) 45b of the cylindrical lens 45a and the extending direction (axial direction) 46b of the cylindrical lens 46a coincide with each other, and are orthogonal to both the direction 44c and the extending direction of the side 43.

On the other hand, as shown in FIG. 10, an attenuator 49 is installed on the side 48 of the framework 41 opposed to the side 43. The attenuator 49 is operable to attenuate laser light. The attenuator 49 only needs to eliminate incoming laser light without leaking it outside. For example, the attenuator 49 can be an optical system in which the arrangement of the above optical system installed on the side 43 is reversed, a housing with a mirror stuck inside at an angle of preventing incoming light from traveling retrodirectively, or a translucent member for attenuating light while transmitting it therethrough.

Also in the suspended particle detector 4 according to this embodiment, the camera 14, the image processor 15, and the display 16 can be provided to image the light reflected by a particle. Alternatively, without using these means, the light reflected by a particle can be observed with the naked eye.

Next, the operation of this embodiment is described.

As shown in FIGS. 10 and 11, in the suspended particle detector 4 according to this embodiment, the laser light emitted from the laser source 11 (see FIG. 1) is guided through the optical fiber 47 to the diameter expander 44 and emitted as a beam B₀. In the diameter expander 44, the traveling direction of the laser light is expanded by the plano-concave lens 44a and collimated by the plano-convex lens 44b. Thus the beam B₀ is expanded in diameter, resulting in a beam B₁. Then, the beam B₁ is expanded in the extending direction of the side 43 by passing through the cylindrical lens 45a of the distributor 45, and collimated in the extending direction of the side 43 by passing through the cylindrical lens 46a of the collimator 46. Thus the beam B₁ is elongated in the extending direction of the side 43, resulting in a beam B₂. The beam B₂ has a sheet-like shape, in which the thickness is equal to the diameter of the beam B₁, and the width is generally equal to the length of the opening 42 in the extending direction of the side 43.

The beam B₂ emitted from the collimator 46 travels in the opening 42 toward the side 48 and impinges on the attenuator 49 installed on the side 48, where it is attenuated and vanishes. Thus, as it were, a sheet of laser light is stretched in the opening 42 of the framework 41. That is, the sheet-like space S in which the laser light is distributed is located only inside the opening 42. When a particle travels in this opening 42, the laser light is reflected by the particle, and the reflected light is captured by the camera 14 (see FIG. 1) or a human observer. The method for imaging a particle using the camera 14, the image processor 15, and the display 16 is the same as that in the above first embodiment.

Next, the effect of this embodiment is described.

According to this embodiment, the sheet-like space S in which the laser light is distributed is formed only inside the opening 42. Thus, there is no leakage of laser light outside the framework 41. Hence the surrounding environment is not affected by laser light. Furthermore, the optical system composed of the diameter expander 44, the distributor 45, the collimator 46, and the attenuator 49 is integrally installed on the framework 41, and the laser source 11 is coupled thereto through the optical fiber 47. Hence, particle detection can be conveniently performed at any place by carrying the framework 41 thereto. For example, in the case where the flow of particles in the environment reaches a certain amount, an inspector can position the framework 41 by hand at any place, and can thereby observe the flow of particles at that place. By performing observation while varying the position and angle of the framework 41, the overall flow of particles in that environment can be ascertained.

In this embodiment, the collimator 46 is provided to collimate the traveling direction of laser light in the opening 42. Hence the intensity of laser light in the opening 42 can be made uniform. Thus, an identical particle exhibits an equal intensity of reflected light wherever in the opening 42 it travels, and the particle can be precisely detected. Furthermore, as described later in the fifth embodiment, when the size of a particle is estimated on the basis of the intensity of reflected light, the precision of the estimation can be improved. Moreover, collimation of the traveling direction of laser light allows the framework 41 to have a rectangular shape. Alternatively, in this embodiment, the collimator 46 can be omitted, and the framework can be formed in a sector shape. Furthermore, the distributor can be a rotary mirror instead of the cylindrical lens. The effect other than the foregoing in this embodiment is the same as that in the above first embodiment.

Next, a fifth embodiment of the invention is described.

In this embodiment, when a suspended particle is detected using the suspended particle detector according to any of the above first to fourth embodiment, the camera 14 and the image processor 15 (see FIG. 1) are used to estimate the size of the particle quantitatively.

In this embodiment, the detection described above is performed beforehand on reference particles having known sizes to determine a conversion formula expressing the relationship between the particle size and the intensity of reflected light, and the conversion formula is stored in the image processor 15. Thus, when an unknown particle is detected, the intensity of light reflected by the particle can be used as an input to the conversion formula to estimate the size of this particle.

It is noted that particles have different shapes and surface conditions depending on the types thereof. The relationship between the particle size and reflected light intensity slightly depends on the shape or surface condition. However, also in this case, according to this embodiment, the particle size can be evaluated at least relatively. For example, it is considered that particles occurring from a particular particle source are of the same type. Hence, when a countermeasure is taken against this source, such as putting a cover thereon, the change of distribution in particle size resulting from the countermeasure can be evaluated in addition to the change of distribution in the number of particles.

In this embodiment, to accurately estimate the particle size, the influence of ambient illumination is preferably taken into consideration. This is because, while the ambient illumination generally depends on the place of detection, the particle size distribution can be accurately compared between different places by taking the influence of ambient illumination into consideration. Furthermore, even at the same place, if a cover is put on the particle source, for example, the ambient illumination may be affected by the presence of this cover. Also in such cases, the effect of the countermeasure can be accurately evaluated if the detection result can be accurately compared between before and after the countermeasure. In the following, specific methods for taking the influence of ambient illumination into consideration are described.

As a first method, the ambient illumination can be made constant using a reference body.

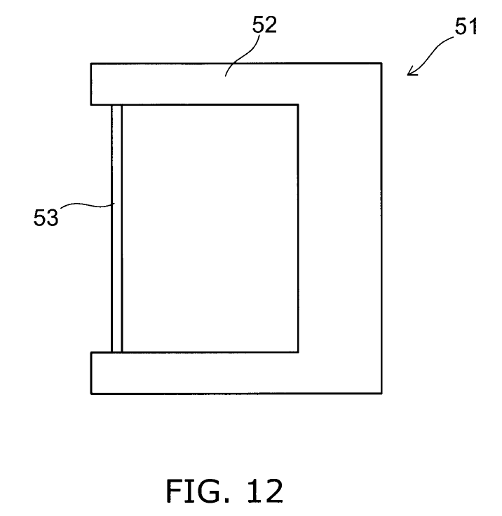

FIG. 12 is a side view illustrating a jig used in this embodiment.

As shown in FIG. 12, the jig 51 used in this embodiment comprises a square U-shaped support 52. One wire 53 is stretched between the ends of the support 52. The diameter of the wire is preferably comparable to the size of particles to be detected, and is illustratively several ten microns. This wire 53 serves as a reference body in this embodiment.

First, before particle detection, laser light reflected by the wire 53 is measured. Specifically, the wire 53 is positioned in the sheet-like space S formed by the suspended particle detector, and the camera 14 is placed outside the space S. Here, the positional relationship among the space S, the wire 53, and the camera 14 is always kept unchanged. In this condition, the laser source 11 is caused to emit laser light, and light reflected by the wire 53 is captured by the camera 14. In the image data obtained by the camera 14, the number of pixels in the portion corresponding to the wire 53 and the brightness distribution of these pixels are measured.

Then, the ambient illumination is adjusted so that the number of pixels and the brightness distribution thereof in the portion corresponding to the wire 53 are kept constant. Subsequently, detection of suspended particles to be evaluated is performed. Consequently, particle detection can be always performed under the environment having constant illumination. Hence the particle size can be accurately compared between detection events. It is noted that, in this embodiment, a plurality of wires having different diameters can be used to determine the above conversion formula.

As a second method, the detection result can be compensated in accordance with ambient illumination.

Specifically, the data for the influence of ambient illumination on the relationship between particle size and reflected light intensity is stored beforehand in the image processor 15. This stored information is used to compensate the detection result and estimate the particle size. Thus, the particle size can be accurately estimated even when the ambient illumination cannot be adjusted and the above first method cannot be used.

It is noted that the image processor 15 can also store the data for influence of detection conditions such as the type of the laser, the positional relationship among various means, and the position of the particle in the space S, in addition to the ambient illumination, and serve a function of compensating the detection result in accordance with these detection conditions. Thus the particle size can be estimated more accurately.

The invention has been described with reference to the embodiments. However, the invention is not limited to these embodiments. For example, the above embodiments can be suitably modified through addition, deletion, and/or design change of the components by those skilled in the art without departing from the spirit of the invention, and any such modifications are also encompassed within the scope of the invention. Furthermore, the above embodiments can also be practiced in combination with each other.

1. An apparatus for detecting suspended particles, comprising:
a laser source configured to emit a beam of laser light;
a diameter expander configured to expand the diameter of the beam; and
a distributor configured to distribute the laser light in a sheet-like space.

2. The apparatus for detecting suspended particles according to claim 1, wherein the distributor varies the traveling direction of the laser light in continuous directions at a fixed angle with respect to a reference axis.

3. The apparatus for detecting suspended particles according to claim 1, further comprising:
an optical fiber having one end coupled to the laser source; and
a housing coupled to the other end of the optical fiber and equipped inside with the diameter expander and the distributor.

4. The apparatus for detecting suspended particles according to claim 1, further comprising:
a framework equipped on one side thereof with the diameter expander and the distributor and containing the sheet-like space in which the laser light is distributed; and
an attenuator installed on another side of the framework and configured to attenuate the laser light.

5. The apparatus for detecting suspended particles according to claim 4, further comprising:
a collimator installed on the one side of the framework and configured to align the traveling directions of laser light emitted from the distributor with each other.

6. The apparatus for detecting suspended particles according to claim 1, further comprising:
a camera placed outside the sheet-like space and configured to detect the laser light reflected by a particle traveling in the sheet-like space.

7. The apparatus for detecting suspended particles according to claim 6, further comprising:
a band-pass filter covering a light receiving section of the camera, wherein the transmittance of the band-pass filter to light in a wavelength band including the wavelength of the laser light is higher than the transmittance to light having wavelengths outside this wavelength band.

8. The apparatus for detecting suspended particles according to claim 6, further comprising:
an image processor connected to the camera and configured to store a conversion formula expressing a relationship between the size of a particle and the intensity of light reflected by the particle and estimate the size of the particle from a detection result of the reflected light.

9. The apparatus for detecting suspended particles according to claim 1, wherein the distributor includes:
a mirror configured to reflect the beam; and
a driver configured to vary the normal direction of the mirror about a reference axis.

10. The apparatus for detecting suspended particles according to claim 1, wherein the distributor includes a cylindrical lens.

11. The apparatus for detecting suspended particles according to claim 1, wherein the distributor includes:
a polygonal prism with side faces made of mirrors; and
a driver configured to rotate the polygonal prism about its central axis.

12. A method for detecting suspended particles, comprising:
expanding the diameter of a beam of laser light;
distributing the laser light in a sheet-like space; and
detecting the laser light reflected by a particle traveling in the sheet-like space.

13. The method for detecting suspended particles according to claim 12, wherein said distributing is performed by varying the traveling direction of the laser light in continuous directions at a fixed angle with respect to a reference axis.

14. The method for detecting suspended particles according to claim 12, wherein the sheet-like space is located inside a framework.

15. The method for detecting suspended particles according to claim 12, wherein said detecting the reflected light is performed by a camera placed outside the sheet-like space.

16. The method for detecting suspended particles according to claim 14, further comprising:
using a conversion formula expressing a relationship between the size of a particle and the intensity of light reflected by the particle to estimate the size of the particle from a detection result of the reflected light.

17. The method for detecting suspended particles according to claim 15, further comprising:
positioning a reference body in the sheet-like space; and
adjusting ambient illumination so that, in an image in which light reflected by the reference body is captured by the camera, the number of pixels and the brightness distribution thereof in a portion corresponding to the reference body are kept constant.

18. The method for detecting suspended particles according to claim 12, wherein said distributing the laser light is performed by, while varying the normal direction of a mirror about a reference axis, causing the mirror to reflect the beam.

19. The method for detecting suspended particles according to claim 12, wherein said distributing the laser light is performed by causing the beam to pass through a cylindrical lens.

20. The method for detecting suspended particles according to claim 12, wherein said distributing the laser light is performed by, while rotating a polygonal prism with side faces made of mirrors about its central axis, causing the mirrors to reflect the beam.
